(19) United States
(12) Patent Application Publication
(10) Pub. No.: US 2016/0249742 A1
(43) Pub. Date: Sep. 1, 2016

(54) Component Positioning Structure for Combination Sofa

(71) Applicant: HK LianHua Sponge Furniture Ltd., Kowloon (HK)

(72) Inventor: Sheng-Lin Xie, Shenzhen City (CN)

(21) Appl. No.: 14/631,911

(22) Filed: Feb. 26, 2015

(51) Int. Cl. A47C 4/02; F16B 12/44

(52) U.S. Cl. CPC A47C 4/028; F16B 12/44

(57) ABSTRACT

Disclosed is a component positioning structure for a combination sofa. The predetermined connecting section of each component of the sofa is mounted with wedge-shaped connecting elements. Once all the components are completed, the corresponding connecting elements of each two adjacent components are connected to facilitate assembly of the sofa and to ensure the components are accurately positioned. Moreover, the component positioning structure allows the components to be stacked for shipment, thus reducing the space occupied. If a certain component of the sofa needs to be reupholstered, this component can be detached without impairing the accuracy with which its wedge-shaped connecting elements connect with the corresponding connecting elements.

### BACKGROUND OF THE INVENTION

1. Technical Field

The present invention relates to a component positioning structure for a combination sofa. More particularly, the present invention relates to a component positioning structure which enables the components of a sofa to be accurately positioned in a predetermined manner by a simple and rapid operation during assembly; which allows each component of the sofa to be easily detached for reupholstery in case of wear or damage without impairing the accuracy of connection between the components; and which enhances the efficiency and accuracy of connection of the connecting elements of the sofa.

2. Description of Related Art

A conventional sofa typically includes a base, two lateral (i.e., left and right) components, a backrest, and a seat cushion supported on the base. During assembly, the aforesaid components excluding the seat cushion are fastened or fixed together by a fixing means such as screws of predetermined lengths, before the seat cushion is placed on the base to make a sofa of a predetermined configuration. While one can lie on or sit in such a sofa comfortably, difficulty may arise when the sofa needs repairing. For example, a certain component of the sofa may be worn, discolor, or crack after long-term use, but since the entire structure is fastened or nailed together, it is practically impossible to detach a particular component without damaging the connecting surfaces of all affected components. Therefore, should any component of the sofa become worn or slightly damaged, surface patching is all that can be done now that it is unfeasible to detach only the damaged component for repair. If the owner of the sofa considers surface patching unacceptable due to esthetic considerations, there is no other way than to throw the sofa away. This may explain why so many sofas which are still functional are discarded as garbage.

In addition to not allowing a worn component to be detached for repair, the aforesaid conventional sofa requires due attention during assembly. If a fastening element between two components of the sofa is driven askew or into a wrong place and then unscrewed, the same or a new fastening element must be driven into the same components at a different position. Because of that, the assembly of the sofa demands expertise and can be time-consuming.

The inventor of the present invention provides improvement over the positioning mechanism of the components of sofas of the foregoing kind. It is hoped that, during assembly, the components of such a sofa can be positioned in a predetermined manner by a simple and rapid operation. It is also desirable that, if any component of the sofa is worn and needs repairing, this component can be easily detached and reupholstered without compromising the accuracy with which this component connects with the corresponding component(s). The goal is to enhance the efficiency and accuracy of assembly of the sofa.

### BRIEF SUMMARY OF THE INVENTION

The present invention is intended to solve the positioning problem of the components of a conventional sofa and provide improvement over the fact that a conventional sofa does not allow partial detachment for reupholstery. To this end, it is desirable that the predetermined connecting section of each component of a sofa is mounted with wedge-shaped connecting elements, that the connecting elements of each two adjacent components can be stably connected once all the components are completed, that the components can be accurately connected by a simple operation during assembly of the sofa, that the components can be stacked together during shipment to save space, and that each component of the sofa can be detached for reupholstery without compromising the accuracy with which the components connect with one another.

The primary objective of the present invention is to provide a component positioning structure for a combination sofa. The component positioning structure allows the components of the sofa to be accurately positioned with respect to one another by a simple fastening operation, wherein the components of the sofa at least include a left armrest, a right armrest, a backrest, and a base. The component positioning structure is characterized in that each of the left armrest, the right armrest, the backrest, and the base has at least one predetermined connecting section mounted with at least one connecting element. More specifically, each of the left and right armrests has an inner side having a predetermined connecting section mounted with at least one first wedge-shaped connecting element, each of the backrest and the base has two lateral sides each having a predetermined connecting section concavely provided with a receiving area, and each receiving area has an appropriate depth and a predetermined portion mounted with at least one second wedge-shaped connecting element. To assemble the sofa, the second wedge-shaped connecting elements mounted on the receiving areas of the two lateral sides of the base are respectively aligned with and inserted into lower ones of the first wedge-shaped connecting elements mounted on the inner sides of the left and right armrests, and the second wedge-shaped connecting elements mounted on the receiving areas of the two lateral sides of the backrest are respectively aligned with and inserted into upper ones of the first wedge-shaped connecting elements mounted on the inner sides of the left and right armrests. Thus, the components of the sofa are accurately positioned with respect to one another in a simple and rapid manner.

The second objective of the present invention is to provide the foregoing component positioning structure, wherein the first wedge-shaped connecting elements mounted on the predetermined connecting sections of the inner sides of the left and right armrests are wedge-shaped elements with a downwardly decreasing width, and so are the second wedge-shaped connecting elements mounted on the receiving areas of the predetermined connecting sections of the two lateral sides of each of the backrest and the base. In addition, each first wedge-shaped connecting element has a predetermined section provided therein with a positioning block and has an interior into which the corresponding second wedge-shaped connecting element can be securely inserted, and the positioning block of each first wedge-shaped connecting element is configured to facilitate positioning of the corresponding second wedge-shaped connecting element.

The third objective of the present invention is to provide the foregoing component positioning structure, wherein in order to mount the at least one first wedge-shaped connecting element on the predetermined connecting section of the inner side of each of the left and right armrests and to mount the at least one second wedge-shaped connecting element on the receiving area of the predetermined connecting section of each lateral side of each of the backrest and the base, at least one internally threaded locking element is implanted into the predetermined connecting section of the inner side of each of the left and right armrests as well as into the receiving area of the predetermined connecting section of each lateral side of each of the backrest and the base. Thus, each first wedge-shaped connecting element can be locked to the corresponding locking element in each of the left and right armrests, and each second wedge-shaped connecting element, to the corresponding locking element in each of the backrest and the base, by a threaded fastener.

### BRIEF DESCRIPTION OF THE SEVERAL VIEWS OF THE DRAWINGS

FIG. 1 is an exploded view of the right armrest of a sofa and a plurality of first wedge-shaped connecting elements according to the present invention;

FIG. 2 is a partial exploded view of the backrest of a sofa and a plurality of second wedge-shaped connecting elements according to the present invention;

FIG. 3 is a partial exploded view of the base of a sofa and a plurality of second wedge-shaped connecting elements according to the present invention;

FIG. 4 is an exploded view of the components of a sofa according to the present invention in an unassembled state;

FIG. 5 is an exploded view showing how a second wedge-shaped connecting element for use in a sofa according to the present invention is inserted into a first wedge-shaped connecting element;

FIG. 6 is a sectional view taken along line 60-60 in FIG. 5;

FIG. 7 is an assembled view of the components of a sofa according to the present invention, wherein the seat cushion is not in place;

FIG. 8 is a sectional view of the circled area 80 in FIG. 7, showing the engagement between a first wedge-shaped connecting element on the left armrest of the sofa in FIG. 7 and a second wedge-shaped connecting element; and

FIG. 9 is an assembled view of a sofa according to the present invention, with the seat cushion in place.

### DETAILED DESCRIPTION OF THE INVENTION

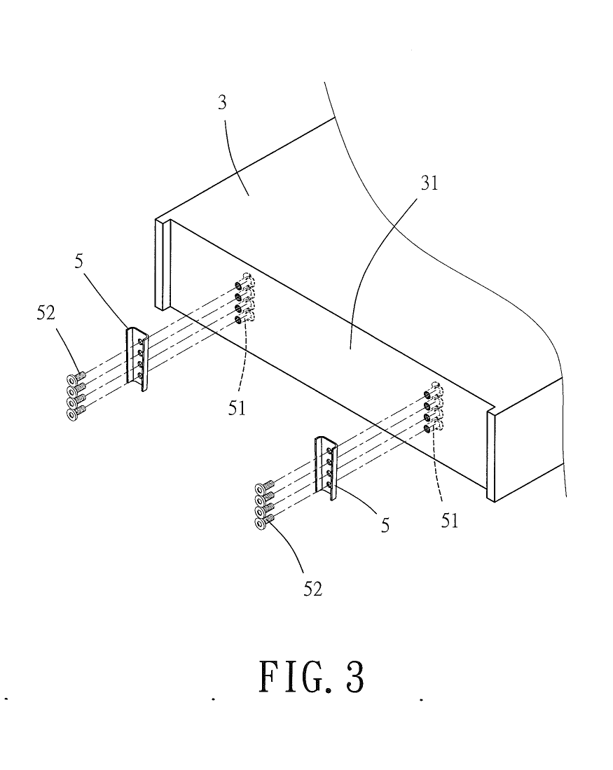

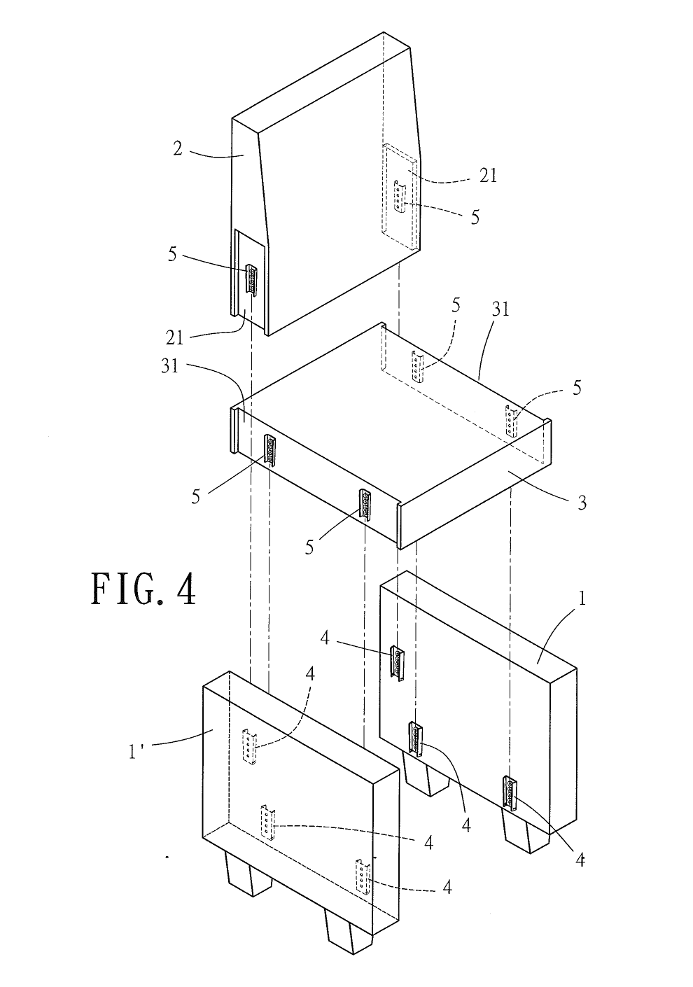

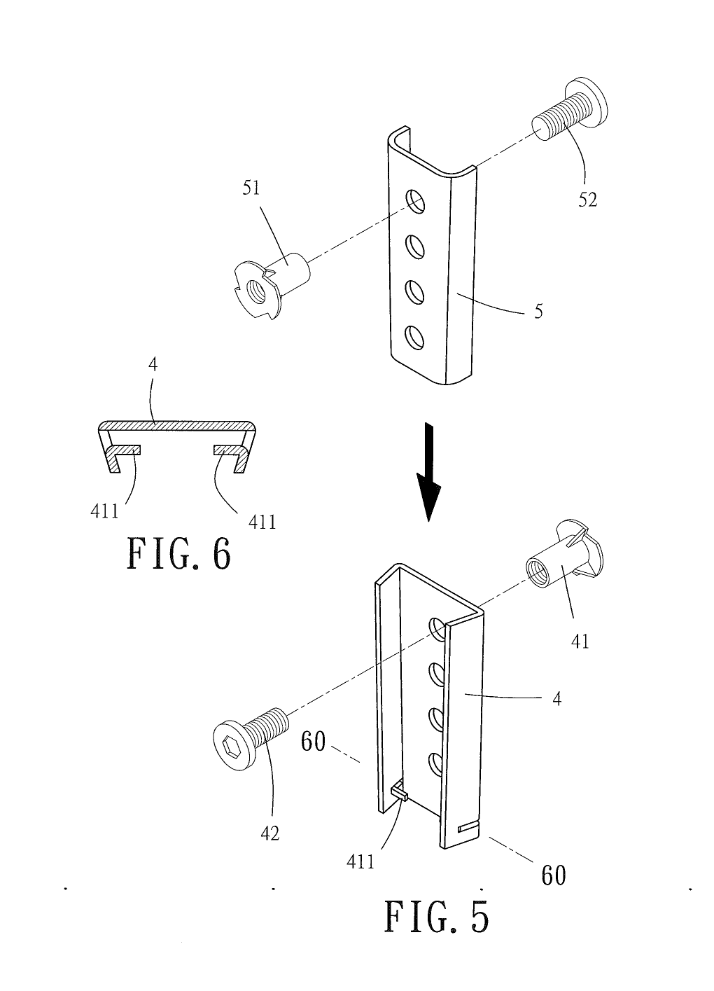

The present invention provides a component positioning structure for a combination sofa (FIG. 3) so that the components of the sofa can be accurately positioned with respect to one another by a simple fastening operation. The sofa 6 includes a right armrest 1, a left armrest 1′, a backrest 2, and a base 3. The aforesaid components of the sofa 6 have predetermined connecting sections mounted respectively with first or second wedge-shaped connecting elements (see FIG. 4, FIG. 5).

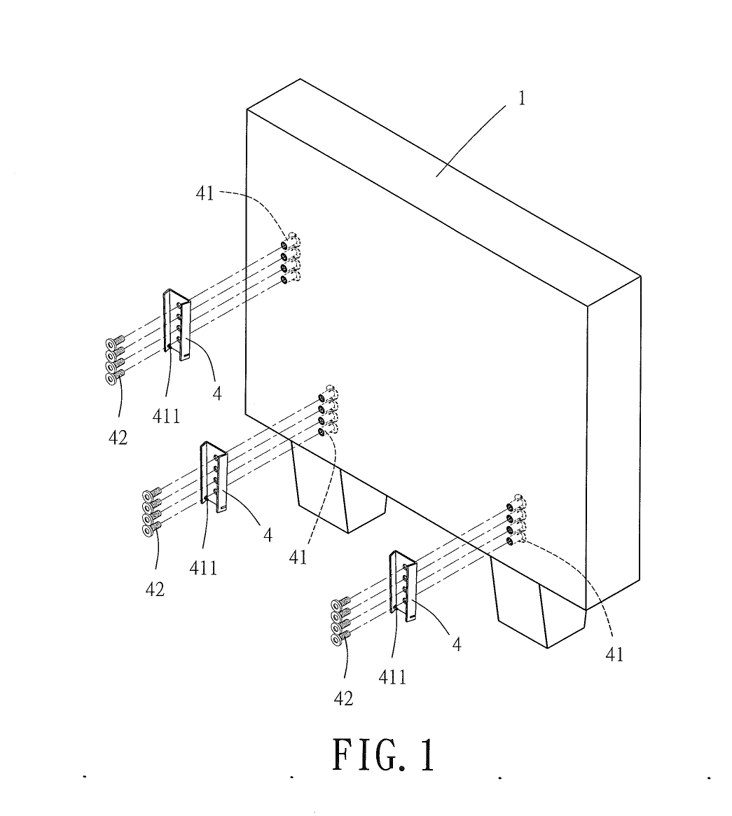

The inner side of the right armrest 1 is provided with a predetermined connecting section mounted with at least one first wedge-shaped connecting element 4 (see FIG. 1). In this embodiment, two first wedge-shaped connecting elements 4 of the same height are mounted to a front lower end and a rear lower end of the inner side of the right armrest 1 respectively so that the right armrest 1 can be fastened with the base 3. In addition, the rear upper end of the inner side of the right armrest 1 is mounted with another first wedge-shaped connecting element 4 so that the right armrest 1 can be fastened with the backrest 2. The first wedge-shaped connecting elements 4 mounted on the predetermined connecting section of the inner side of the right armrest 1 are wedge-shaped elements whose width decreases downward. Moreover, each of the first wedge-shaped connecting elements 4 has a predetermined section provided therein with a positioning block 411 to facilitate positioning of the corresponding second wedge-shaped connecting element 5. (The interior of each first wedge-shaped connecting element 4 is so designed that the corresponding second wedge-shaped connecting element 5 can be inserted therein securely.) On the other hand, a plurality of internally threaded locking elements 41 are driven into the predetermined connecting section of the inner side of the left armrest 1′ so that the first wedge-shaped connecting elements 4 to be mounted to the predetermined connecting section of the inner side of the left armrest 1′ can be locked to the locking elements 41 by a plurality of threaded fasteners 42 respectively (see FIG. 4, FIG. 5).

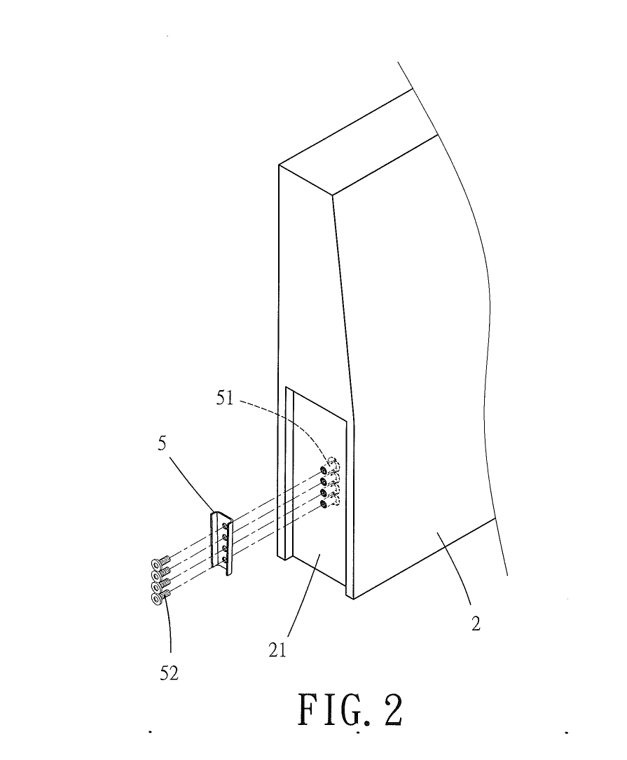

Each of the backrest 2 and the base 3 has two lateral sides each having a predetermined connecting section, wherein each predetermined connecting section is concavely provided with a receiving area 21, 31 of an appropriate depth (see FIG. 2, FIG. 3). At least one second wedge-shaped connecting element 5 is mounted to a predetermined portion of each receiving area 21, 31. The second wedge-shaped connecting elements 5 mounted on the receiving areas 21, 31 of the predetermined connecting sections of the two lateral sides of each of the backrest 2 and the base 3 (referring to FIG. 2 for the backrest 2 for example) are wedge-shaped elements whose width decreases downward. In order to mount the second wedge-shaped connecting elements 5 to the receiving areas 21, 31 of the predetermined connecting sections of the two lateral sides of each of the backrest 2 and the base 3, a plurality of internally threaded locking elements 51 are implanted into the receiving areas 21, 31 of the predetermined connecting sections of the two lateral sides of each of the backrest 2 and the base 3. Then, the second wedge-shaped connecting elements 5 to be mounted are locked to the locking elements 51 in the backrest 2 and in the base 3 by a plurality of threaded fasteners 52 respectively. (As the second wedge-shaped connecting elements 5 are mounted to the base 3 (see FIG. 3) in the same way as to the backrest 2, the locking of the second wedge-shaped connecting elements 5 is not described repeatedly for both the base 3 and the backrest 2).

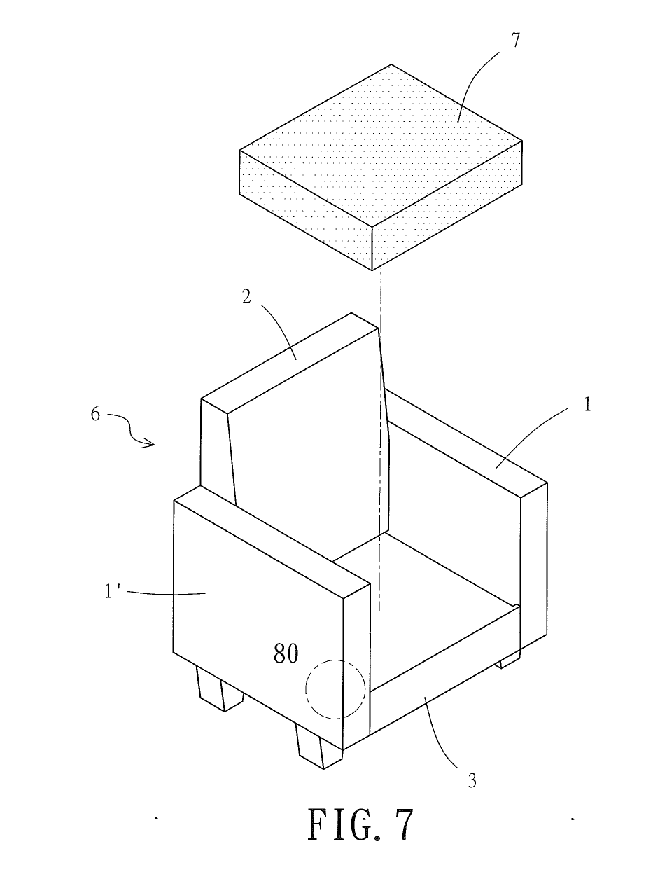

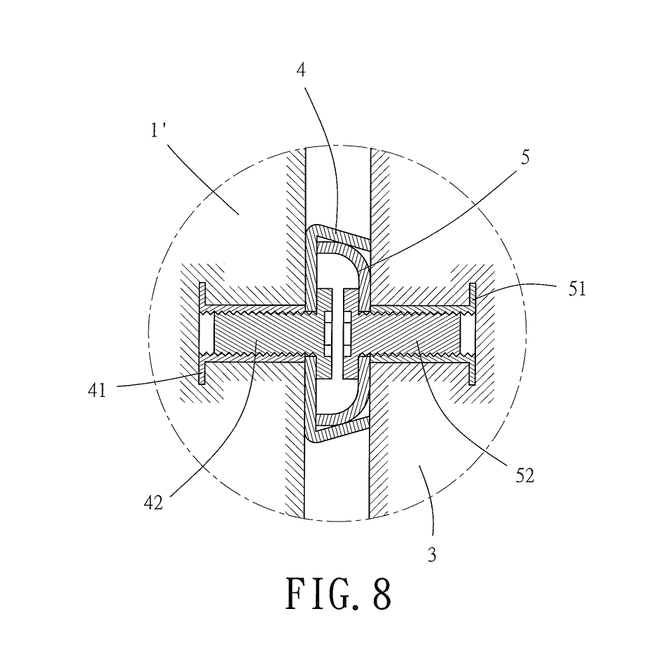

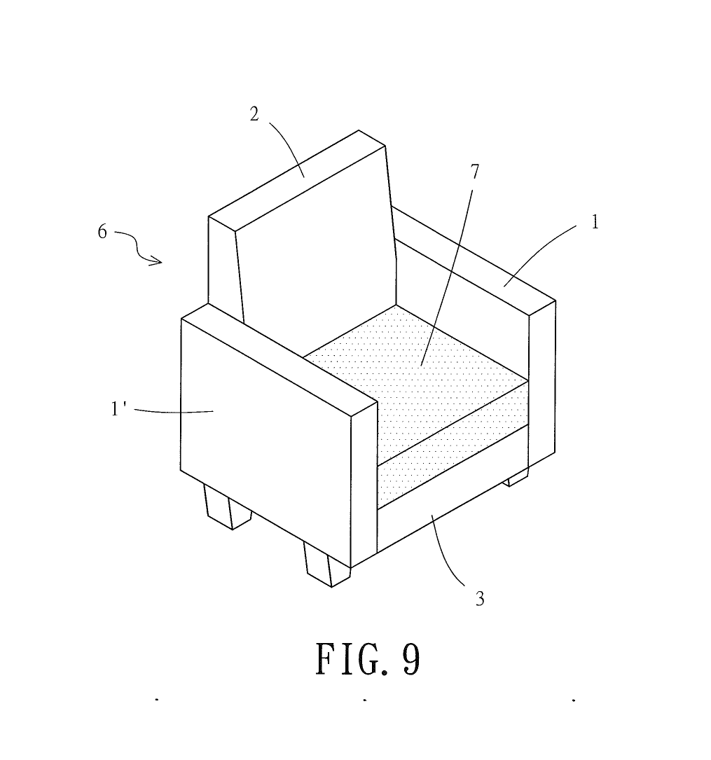

The left and right armrests 1, 1′, the backrest 2, and the base 3 are put together in the following manner (see FIG. 4, FIG. 5, FIG. 6, FIG. 7, FIG. 8, FIG. 9). First, the second wedge-shaped connecting elements 5 mounted on the receiving areas 31 of the two lateral sides of the base 3 are respectively aligned with and inserted into the lower first wedge-shaped connecting elements 4 mounted on the inner side of each of the left and right armrests 1, 1′. Then, the second wedge-shaped connecting elements 5 mounted on the receiving areas 21 of the two lateral sides of the backrest 2 are respectively aligned with and inserted into the upper first wedge-shaped connecting elements 4 mounted on the inner side of each of the left and right armrests 1, 1′ to form the sofa 6. Last, the seat cushion 7 is placed on the base 3 for enhanced comfort (see FIG. 7, FIG. 9). The component positioning structure of the present invention makes it possible to position the components of the sofa 6 in a predetermined manner with a simple and rapid operation during assembly. Not only that, the components of the sofa 6 can detached and stacked to reduce the space occupied during shipment. Moreover, the components of the sofa 6 can be detached for reupholstery without impairing the accuracy of connection of the components.

What is claimed is:

1. A component positioning structure for a combination sofa, wherein the component positioning structure allows components of the sofa to be accurately positioned with respect to one another by a simple fastening operation, and the components of the sofa comprise a left armrest, a right armrest, a backrest, and a base, the component positioning structure being characterized in that each of the left armrest, the right armrest, the backrest, and the base has at least one predetermined connecting section mounted with at least one connecting element;
wherein each of the left and right armrests has an inner side having a said predetermined connecting section mounted with at least one first wedge-shaped connecting element, each of the backrest and the base has two lateral sides each having a said predetermined connecting section concavely provided with a receiving area of an appropriate depth, and each said receiving area has a predetermined portion mounted with at least one second wedge-shaped connecting element; and
wherein in order to assemble the sofa, the second wedge-shaped connecting elements mounted on the receiving areas of the two lateral sides of the base are respectively aligned with and inserted into lower ones of the first wedge-shaped connecting elements mounted on the inner sides of the left and right armrests, and the second wedge-shaped connecting elements mounted on the receiving areas of the two lateral sides of the backrest are respectively aligned with and inserted into upper ones of the first wedge-shaped connecting elements mounted on the inner sides of the left and right armrests such that the components of the sofa are accurately positioned with respect to one another in a simple and rapid manner.

2. The component positioning structure of claim 1, wherein the first wedge-shaped connecting elements mounted on the predetermined connecting sections of the inner sides of the left and right armrests as well as the second wedge-shaped connecting elements mounted on the receiving areas of the predetermined connecting sections of the two lateral sides of each of the backrest and the base are wedge-shaped elements with a downwardly decreasing width, each said first wedge-shaped connecting element has a predetermined section provided therein with a positioning block and has an interior into which a corresponding said second wedge-shaped connecting element is securely insertable, and the positioning block of each said first wedge-shaped connecting element is configured to facilitate positioning of the corresponding second wedge-shaped connecting element.

3. The component positioning structure of claim 1, wherein in order to mount the at least one first wedge-shaped connecting element on the predetermined connecting section of the inner side of each of the left and right armrests and to mount the at least one second wedge-shaped connecting element on the receiving area of the predetermined connecting section of each said lateral side of each of the backrest and the base, at least one internally threaded locking element is implanted into the predetermined connecting section of the inner side of each of the left and right armrests as well as into the receiving area of the predetermined connecting section of each said lateral side of each of the backrest and the base so that each said first wedge-shaped connecting element can be locked to a corresponding said locking element in each of the left and right armrests, and each said second wedge-shaped connecting element, to a corresponding said locking element in each of the backrest and the base, by a threaded fastener.
